(19) United States
(12) Patent Application Publication
(10) Pub. No.: US 2013/0126697 A1
(43) Pub. Date: May 23, 2013

(54) Rotating car wheel display

(71) Applicant: Steven Harris, Torrance, CA (US)

(72) Inventor: Steven Harris, Torrance, CA (US)

(21) Appl. No.: 13/373,514

(22) Filed: Nov. 17, 2011

(51) Int. Cl. G09F 19/10; F16M 11/18

(52) U.S. Cl. 248/550; 248/176.1

(57) ABSTRACT

The Rotating Car Wheel Display allows perspective customers interested in purchasing a car rim or wheel to see the rim or wheel in motion as it would be on the car itself. It operates in a clockwise and counterclockwise motion for spinning wheels and traditional rims and wheels. It is a portable device that can be displayed easily and inexpensively by any wheel and tire shop for more curb appeal.

### BACKGROUND OF THE INVENTION

(1) Field of the Invention

The “Rotating Car Wheel Display” is a new design for the automotive wheel and tire industry for displaying the wheels in motion opposed to a standard display that has no movement.

(2) Description of the art including information disclosed under 37 CFR 1.97 & 1.98

The art described in the drawings of the design and utility function illustrate the unique ability of the rotating devise both in its use and its safety features that allow it to be used in many environments.

### BRIEF SUMMARY OF THE INVENTION

The “Rotating Car Wheel Display” will rotate any sized car rim or wheel without the use of bolting on the wheel. It can rotate clockwise or counterclockwise or you can choose to have the car rim or wheel rotate and stop in intervals. It allows the customer to see what the wheel looks like in motion.

### BRIEF DESCRIPTION OF THE SEVERAL VIEWS OF THE DRAWINGS

There are 6 drawings in total that describe and illustrate the design and function of the “Rotating Car Wheel Display”.

FIG. 1: is the entire device shown.

FIG. 2: is the control panel diagram.

FIG. 3: is the electric flow of the device.

FIG. 4: is the locking bar and wheel.

FIG. 5: is the view of the wheels.

FIG. 6: is the screw threads and cap.

### DESCRIPTION OF THE PREFERRED EMBODIMENT

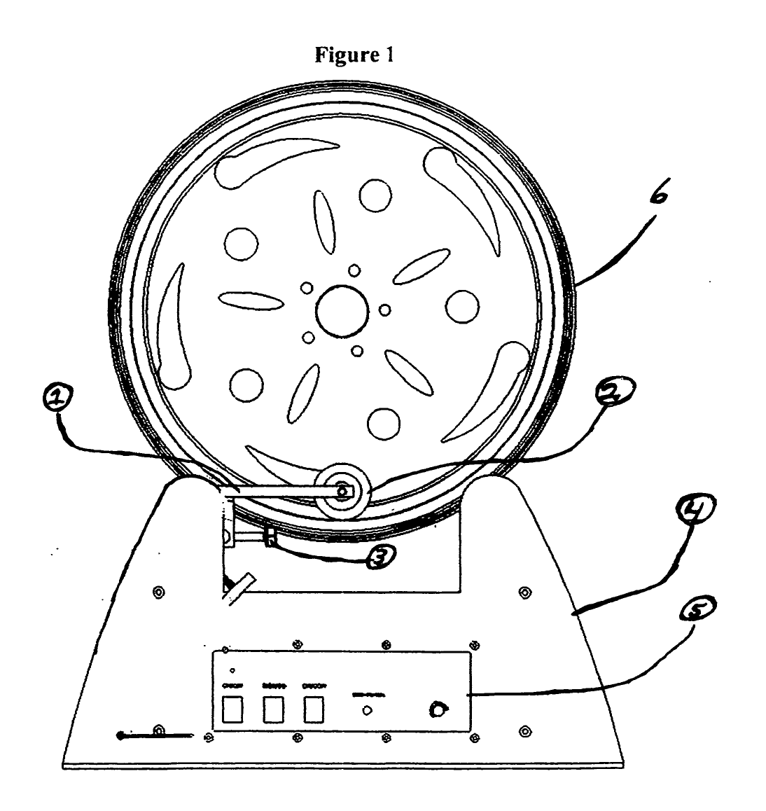

FIG. 1: In illustration #1 the locking bar holds the wheel in place and allows the wheel #2 spin as it holds the car wheel in place and the #3 screw tightens and loosens the locking bar so that it can be moved. In #4 is the body of the device or machine and #5 is the control panel. In #6 it is the car rim or wheel sitting in place atop the device or machine.

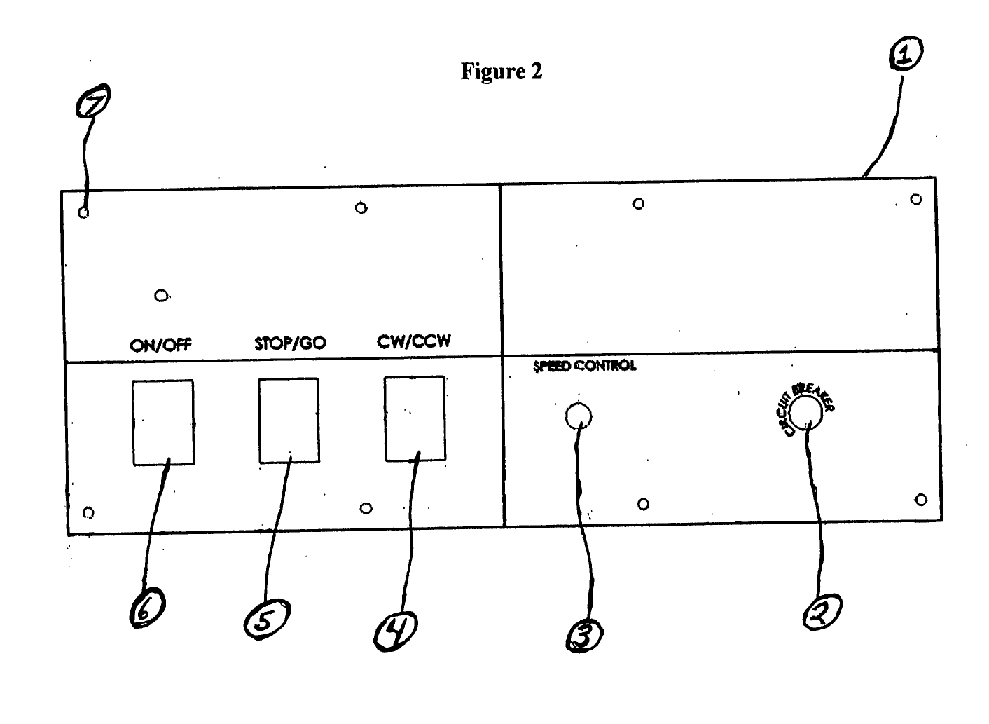

FIG. 2: In illustration #1 is the control panel plate that houses the #2 circuit breaker and the #3 speed control and the #4 CW/CCW switch for directional rotation of the car rim or wheel and #5 the stop /go switch for spinner type rims and #6 is the on/off switch to power the device on or off.

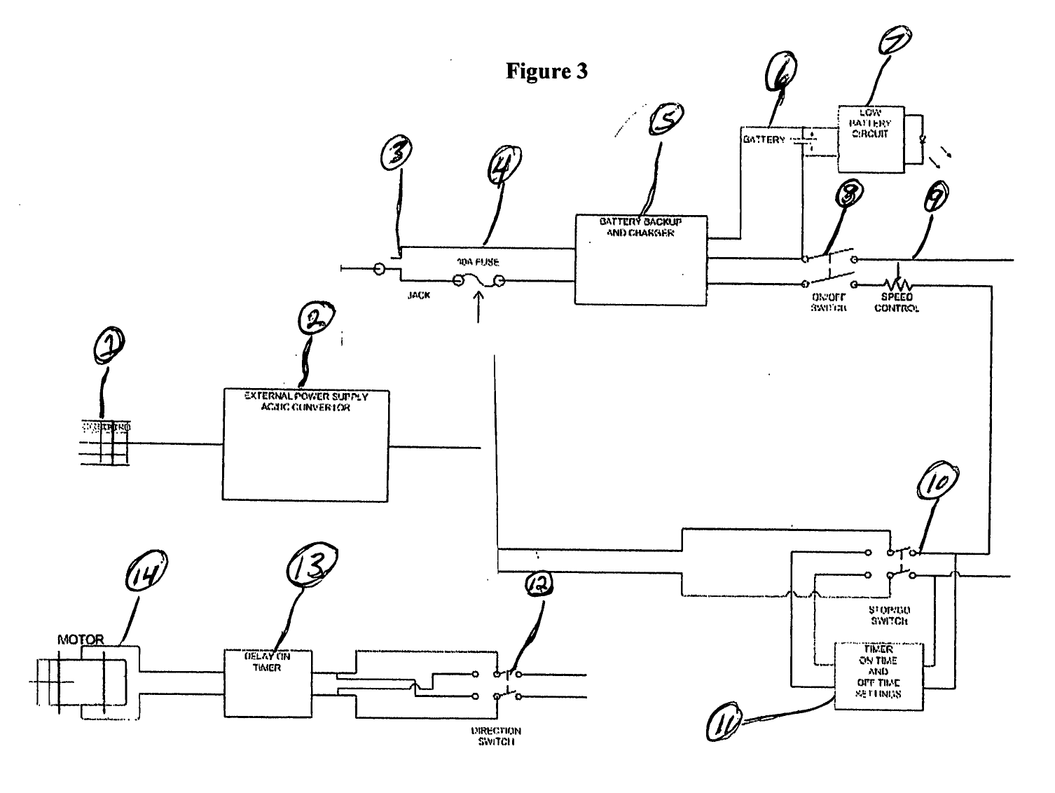

FIG. 3: In this illustration shows the electric flow of the device with the part name starting with the outlet #1 plug flowing into the #2 external power supply and AC/DC converter into the #3 jack and #4 fuse into the #5 battery backup and charger and into the #6 battery and into the #7 low battery circuit into the #8 power on and off switch into the #9 speed control into the #10 stop and go switch into the #11 timer settings circuit into the #12 direction switch into the #13 delay on timer circuit into the #14 motor.

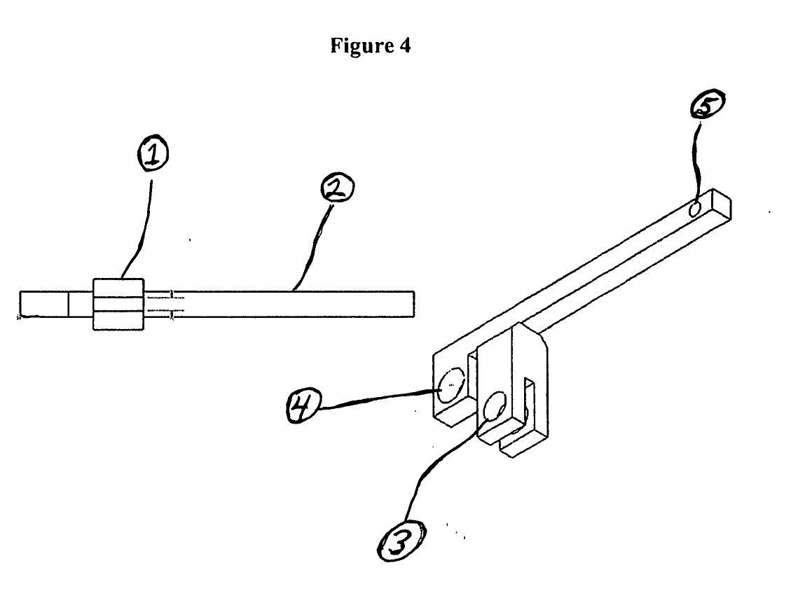

FIG. 4: In this illustration the #1 locking bar armature for leverage and to tighten down or loosen as to its use at the time and #2 the bar itself that is holding the wheel for the device to hold the car rim in place and #3 is the bolt or shaft hole and #4 is the end bar hole to the main shaft of the device to move the bar and wheel back and forth for different sizes of car rims and #5 is the hole for the wheel attachment that holds the car rom in place and allows the car rim to spin.

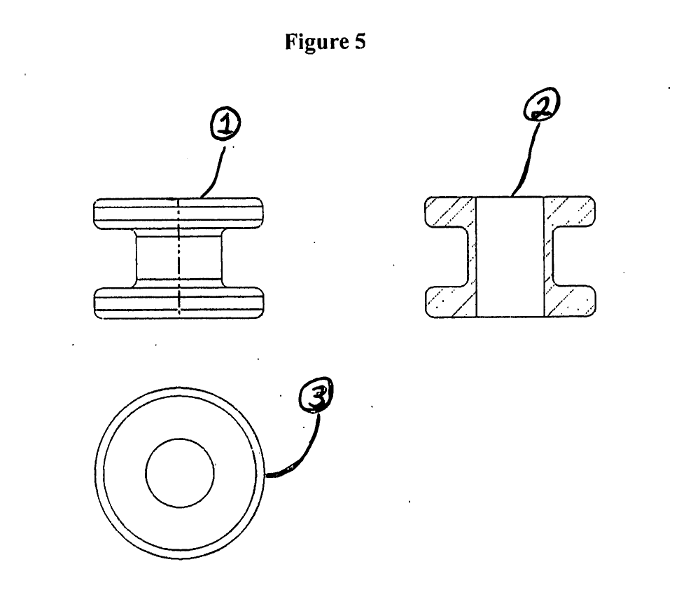

FIG. 5: #1 illustrates the fixed roller wheel and #2 is the adjustable roller moving back and forth and #3 is the side view of the wheels center hole that slips on the main shaft of the device.

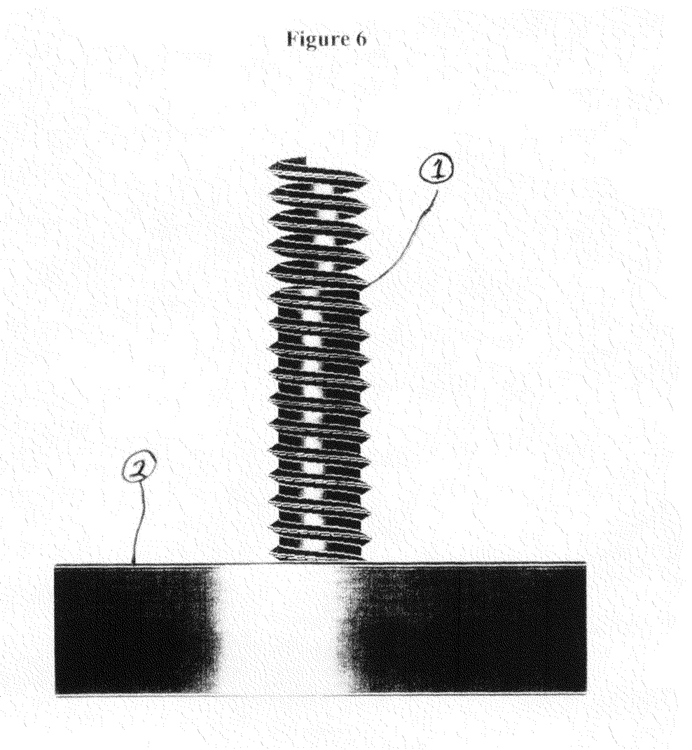

FIG. 6: #1 illustrates the screw threads that are larger for faster movement and tightening or loosening and #2 is the screw cap to easily move the screw in and out of position when tightening or loosening the locking bar.

### DETAILED DESCRIPTION OF THE INVENTION

The “Rotating Car Wheel Display” is a newly designed device and machine that is used for the automotive tire and wheel industry for display purposes. It rotates in a clockwise direction and a counterclockwise direction and can stop and go in a cycle and can operate at different speeds for different wheel weights and sizes. It displays spinner style wheels that can stop and the center will still move and the customer can see how the wheel will look once installed on their vehicle. It has a safety feature which will stop the device from spinning immediately if any friction or slight pressure is applied to the device such as a person's clothing or a child touching the device. The locking bar and wheel allow the car rim to spin freely while being held in place by the locking bar and the attached wheel.

I claim

1. The Rotating Car Wheel Display is one single device or machine that uses an electric motor to rotate a car rim or wheel in a clockwise or counterclockwise motion to display spinning car rims and traditional car rims for the consumer to see what the wheels looks like once on the car itself as it is moving.

2. The locking bar and attached wheel allow the car rim to spin at different speeds and cycles with no encumbrance while being held in place by the locking bar and attached wheel using car rims of different sizes and weights in which the main shaft wheels are adjustable to fit the different sized car rims.

3. The electric flow of the device is unique and has a safety mechanism which will stop the device from spinning immediately upon any friction or outside contact from anything or any person.
